(19) United States
(12) Patent Application Publication
(10) Pub. No.: US 2024/0276928 A1
(43) Pub. Date: Aug. 22, 2024

(54) MODULAR INTERLOCKING EXPANDABLE PLANT TRELLIS

(71) Applicant: Brett Littlejohn-Mifsud, Oxley (AU)

(72) Inventor: Brett Littlejohn-Mifsud, Oxley (AU)

(21) Appl. No.: 18/110,753

(22) Filed: Feb. 16, 2023

(51) Int. Cl. A01G 17/08

(52) U.S. Cl. CPC A01G 17/08

(57) ABSTRACT

A trellis has a plurality of annular frames, which each include a front surface with a plurality of posts, and a rear surface with a plurality of receiving recesses. The annular frames may be joined together by interlocking some of the plurality of posts with receiving recesses of adjacent annular frames. The trellis further includes a base structure for supporting the plurality of annular frames above the ground.

### BACKGROUND OF THE INVENTION

### Field of the invention

This invention relates generally to a plant trellis, and more particularly to a modular interlocking expandable plant trellis.

### Description of Related Art

A typical trellis is a frame often constructed of slats (e.g., wood, bamboo, metal) that supports plants, typically by securing a branch or vine of the plant to the slats via fasteners such as wires, ties, etc.

Modular annular trellis structures are also known; however, the annular components have fasteners on outer edges of each annular structure. While this enables the annular components to be fastened together on their outer edges, they cannot be fastened together in other configurations, and furthermore, there is no mechanism for fastening plants to the annular structures, except for common wires and ties.

The prior art does not teach a modular annular structure that includes posts/receivers on the front and rear faces of the annular structures, thereby enabling a wide range of custom configurations, and further enabling unique fasteners which may be snapped directly onto the annular structures for securing plants to the trellis without the use of wires and snaps. The present invention fulfills these needs and provides further advantages as described in the following summary.

### SUMMARY OF THE INVENTION

The present invention teaches certain benefits in construction and use which give rise to the objectives described below.

The present invention provides a trellis for supporting a plant The trellis includes a plurality of annular frames, which each include a front surface with a plurality of posts, and a rear surface with a plurality of receiving recesses. The annular frames may be joined together by interlocking some of the plurality of posts with receiving recesses of adjacent annular frames. The trellis further includes a base structure for supporting the plurality of annular frames above the ground.

A primary objective of the present invention is to provide a trellis having advantages not taught by the prior art.

Another objective is to provide a trellis that is modular annular structure.

Another objective is to provide a trellis that includes annular frames that include posts/receivers on the front and rear faces of the annular structures, thereby enabling a wide range of custom configurations.

A further objective is to provide a trellis that includes plant support fasteners which may be snapped directly onto the annular structures for securing plants to the trellis without the use of wires and snaps.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a trellis according to one embodiment of the present invention, including a base structure mounted in a planter, and a plurality of annular frames mounted on the base structure.

FIG. 2 is an exploded perspective view of the base structure of the trellis of FIG. 1, illustrating the base structure being inserted into the planter.

FIG. 3 is an exploded perspective view of a second embodiment of the base structure being inserted into a second embodiment of the planter.

FIG. 4 is an exploded rear perspective view of three of the annular frames and a plant support fastener.

### DETAILED DESCRIPTION OF THE INVENTION

The above-described drawing figures illustrate the invention, a plant trellis that is adapted to be mounted on or within a planter for supporting a plant. The trellis is modular in construction, and various components of the trellis are interlocking so that the trellis is expandable and adjustable to meet the needs of a given user.

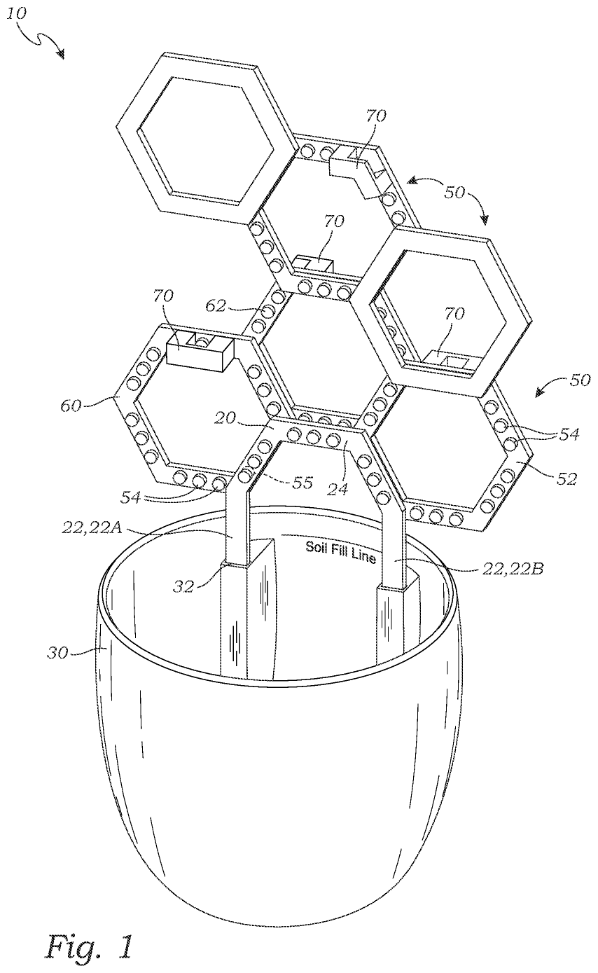

FIG. 1 is a perspective view of a trellis 10 according to one embodiment of the present invention. A shown in FIG. 1, the trellis 10 includes a base structure 20 mounted in a planter 30, and a plurality of annular frames 50 mounted on the base structure 20. The base structure 20 may include a means for interlocking the base structure 20 with the planter 30, when this form of planter 30 is used; however, it may also be used without the planter 30 illustrated. As shown in FIG. 1, the base structure 20 of this embodiment has at least one elongate support post 22 (i.e., one means for interlocking) for supporting the base structure 20 in the planter 30. The support post 22 may be inserted into the planter 30, as illustrated, or it may be merely inserted into soil adjacent the plant (e.g., in a regular prior art planter, or simply into the ground adjacent a plant in a garden).

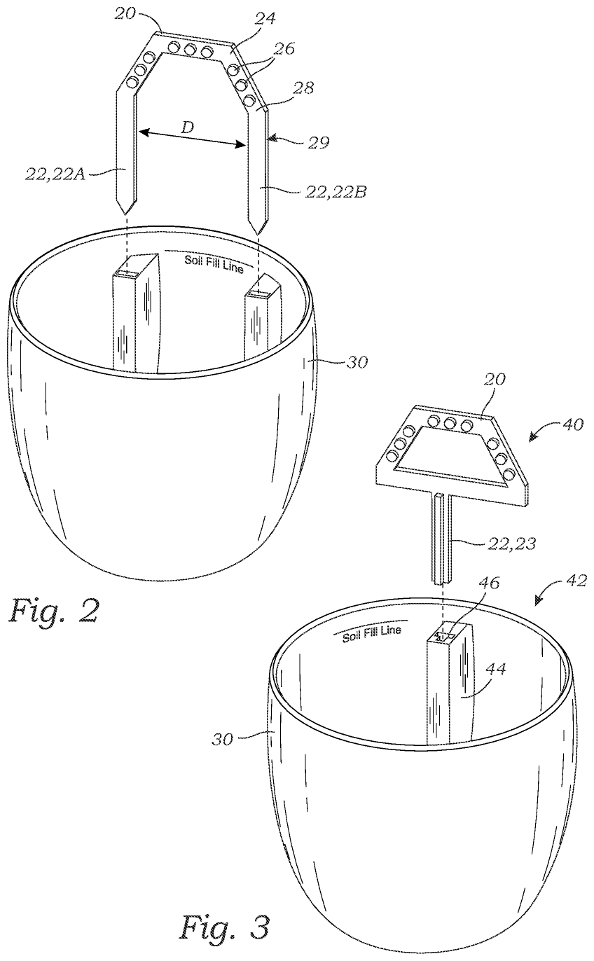

FIG. 2 is an exploded perspective view of the base structure 20 of the trellis 10 of FIG. 1, illustrating the base structure 20 being inserted into the planter 30. In the embodiment of FIGS. 1 and 2, the at least one elongate support post 22 is in the form of a pair of spaced apart support posts 22A and 22B, spaced by a distance D. The support posts 22A and 22B may be inserted into a pair of slotted receivers 32 formed in the planter 30, which are laterally spaced the same distance D as the pair of support posts 22A and 22B, which enables the slotted receivers 32 to slidably receive the support posts 22A and 22B. While this form of interlocking is shown in the current embodiment, the support posts 22A and 22B may have alternative cross-sectional shapes (or other configurations) that interlock with other shapes of receivers 32, and such alternatives should be considered within the scope of the present invention.

In the embodiment of FIGS. 1 and 2, the elongate support post extends 22 upwardly to an interlocking structure 24 that includes a plurality of posts or receiving recesses 26. In this embodiment, as best shown in FIG. 2, the interlocking structure includes posts 26 on a front surface 28 of the structure 24; however, either posts or receiving recesses may be used, and they may be located on the front surface 28, a rear surface 29, or both.

The interlocking structure 24 is shown in the form of an arch made of three faces, which each contain three posts 26, the particular shape and construction of the structure 24 may vary, so long as the front or rear surfaces 28 and 29 include some form of posts, recesses, or other mating structures that enable the annular frames 50 to be mounted thereupon, as described in greater detail below.

FIG. 3 is an exploded perspective view of a second embodiment of the base structure 40 being inserted into a second embodiment of the planter 42. In this embodiment, the at least one elongate support post 22 is a single post 23 having a T-shaped cross-section. This single post 23 slides into a receiving post 44 of the planter 42, the receiving post 44 having a receiving slot 46 that also has a T-shaped cross-section. While this illustrates another embodiment of this invention, obviously other variations may be devised by those skilled in the art, and such alternatives should be considered within the scope of the present invention.

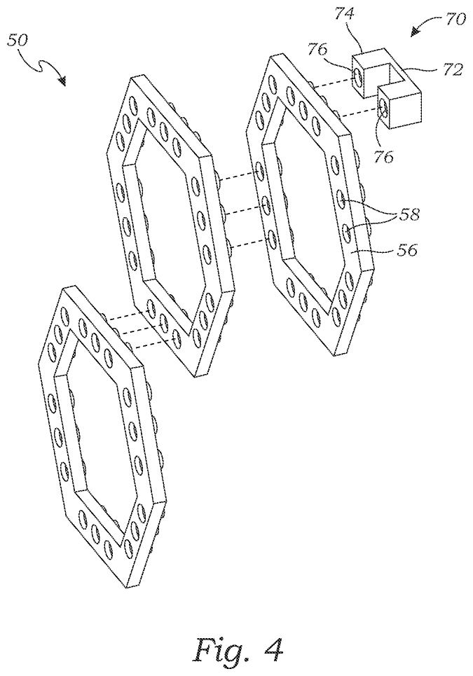

FIG. 4 is an exploded rear perspective view of three of the annular frames 50 of FIG. 1, and also a plant support fastener 70. As shown in FIGS. 1 and 4, each of the plurality of annular frames 50 includes a front surface 52 with a plurality of posts 54 (best shown in FIG. 1), and a rear surface 56 with a plurality of receiving recesses 58 (best shown in FIG. 4).

As shown in FIG. 1, a first 60 of the annular frames 50 may be mounted on the interlocking structure 24 of the base structure 20 by interlocking at least some of the plurality of posts or receiving recesses (in this case posts 54) of the annular frame 50 with at least some of the plurality of posts or receiving recesses (in this case, receiving recesses 55) of the interlocking structure 22 of the base structure 20. Additional annular frames 62 may be mounted on the first 60 of the annular frames 50 in the same manner, by interlocking at least some of the plurality of posts or receiving recesses of the additional annular frames with at least some of the plurality of posts or receiving recesses of the first of the annular frames.

As shown in FIGS. 1 and 4, the plant support fastener 70 may be provided for fastening a plant (not shown) to the trellis 10. As best shown in FIG. 4, the plant support fastener 70 includes a fastener body 72 that extends to ends 74 which each include a post or a receiving recess (in this case, a receiving recess 76), so that the plant support fastener 70 may be removably connected to at least one of the annular frames 50 (as shown in FIG. 1). The fastener body 72 forms an arch which is positioned over a branch, vine, etc., of the plant, for holding it in place, so that a wire or tie is not required. The fastening structure described herein enables the fasteners 70 to be easily snapped into place, moved, or removed, with great ease.

In this embodiment, the plurality of annular frames 50 are each hexagonal in shape, and each side of the hexagonal annular frame 50 has three spaced apart posts 54 on the front surface 52, and three receiving recesses 58 on the rear surface 56. In other embodiments, other shapes (e.g., triangular, rectangular, octagonal, etc.) may be used, and different numbers of or arrangements of posts and receivers may be used, and such alternatives should be considered within the scope of the present invention.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A trellis for supporting a plant, the trellis comprising:
a plurality of annular frames, which each include a front surface with a plurality of posts, and a rear surface with a plurality of receiving recesses;
wherein the annular frames may be joined together by interlocking some of the plurality of posts with receiving recesses of adjacent annular frames; and
a base structure for supporting the plurality of annular frames.

2. The trellis of claim 1, further comprising a plant support fastener that includes a fastener body that extends to ends which each include a post or a receiving recess, so that the plant support fastener may be removably connected to at least one of the annular frames.

3. A trellis for supporting a plant in a planter, the trellis comprising:
a base structure having at least one elongate support post for supporting the base structure in the planter, the elongate support post extending upwardly to an interlocking structure that includes a plurality of posts or receiving recesses;
a plurality of annular frames, which each include a front surface with a plurality of posts, and a rear surface with a plurality of receiving recesses;
wherein a first of the annular frames may be mounted on the interlocking structure of the base structure by interlocking at least some of the plurality of posts or receiving recesses of the annular frame with at least some of the plurality of posts or receiving recesses of the interlocking structure of the base structure; and
wherein additional annular frames may be mounted on the first of the annular frames in the same manner, by interlocking at least some of the plurality of posts or receiving recesses of the additional annular frames with at least some of the plurality of posts or receiving recesses of the first of the annular frames.

4. The trellis of claim 3, further comprising a plant support fastener that includes a fastener body that extends to ends which each include a post or a receiving recess, so that the plant support fastener may be removably connected to at least one of the annular frames.

5. The trellis of claim 3, wherein the base structure includes a pair of support posts.

6. The trellis of claim 5, wherein the planter includes a pair of slotted receivers; and wherein the slotted receivers of the planter are spaced apart a distance that is enables the slotted receivers to slidably receive the support posts therein.

7. The trellis of claim 3, wherein the plurality of annular frames are hexagonal, and each side of the hexagonal annular frame has three spaced apart posts on the front surface, and three receiving recesses on the rear surface.

8. The trellis of claim 3, further comprising a planter, and a means for interlocking the base structure with the planter.
